(19) United States
(12) Patent Application Publication
(10) Pub. No.: US 2021/0320806 A1
(43) Pub. Date: Oct. 14, 2021

(54) SYSTEM AND METHOD FOR IMPROVED BLOCKCHAIN-IMPLEMENTED SMART CONTRACT

(71) Applicant: NEURALIA TECHNOLOGIES INC., Brossard (CA)

(72) Inventor: Jean-Denis BOUDREAULT, Longueuil (CA)

(73) Assignee: NEURALIA TECHNOLOGIES INC., Brossard, QC (CA)

(21) Appl. No.: 17/271,927

(22) PCT Filed: Aug. 28, 2019
(86) PCT No.: PCT/CA2019/051189

§ 371 Date: Feb. 26, 2021

Related U.S. Application Data
(60) Provisional application No. 62/724,688, filed on Aug. 30, 2018.

(51) Int. Cl. H04L 9/32; G06Q 20/40; G06Q 20/38

(52) U.S. Cl. CPC H04L 9/3252; H04L 9/3242; H04L 2209/56; G06Q 20/3829; H04L 2209/38; G06Q 20/405

(57) ABSTRACT

A method and system for validating execution of a smart contract comprises storing the smart contract within a blockchain having at least one first order block. The smart contract has a set of electronically-defined contract clauses, each being defined by at least one satisfaction value, and the combination of the satisfaction values of the set of contract clauses having a satisfaction hash value for the contract. A set of one or more electronically-stored second order transactions each having a subset of one or more execution values is read and a subset of transactions corresponding to the contract clauses are selected. An execution hash value of the combination of execution values of the subset of transaction is determined. A smart contract is considered as fully executed if the execution hash value of the combination of execution values of the subset of transactions matches the satisfaction hash value of the smart contract.

### RELATED PATENT APPLICATION

The present application claims priority from U.S. provisional patent application no. 62/724,688, filed Aug. 30, 2018 and entitled “SYSTEM AND METHOD FOR IMPROVED BLOCKCHAIN-IMPLEMENTED SMART CONTRACT”, the disclosure of which is hereby incorporated by reference in its entirety.

### TECHNICAL FIELD

The present disclosure generally relates to blockchain technology, and more particularly to systems and methods for implementing smart contracts on a blockchain technology.

### BACKGROUND

A blockchain is a series of operations or transactions that are cemented into a sequential append only database format. An important technology making blockchains possible is the hashing algorithm. A cryptographic hash is an algorithm that will take any input value, and for each unique input value, always produce a unique output. The same input will always create the same output, but no two different input will ever create the same output. This way, a hash is a way to create a unique identifier for specific content, where the original content that produced the hash may never be deduced from the resulting hash alone.

Each new piece of content is confirmed into a blockchain database by being included into a block. Each block will contain one or more pieces of content that have been confirmed as cryptographically valid. When a new block is created, its contents will be hashed combining the hash of the previous block in the chain. This goes on and on as the blockchain grows forming a chain of blocks. This technology is interesting, as there is no way an attacker can change anything in the blockchain. Any tampering with the content data as an attempt to corrupt it, even the smallest digit will completely change the hashing chain sum and corrupt the links. This is important, as it allows to ensure that data received from untrusted computers on the internet is valid, by summing up the chain of hashes.

A blockchain database, with its cryptographic chain of hashes, ensures that it is impossible to tamper with its data. This way, computers connected to each other in a somewhat random manner can create a self healing peer to peer network. Each computer connects to other nodes on the network, and they themselves connect to others, forming a communication mesh. If one peer should become unresponsive, the network is never affected as it will naturally rebalance itself using other connections. The peers on this network will exchange and synchronize the blockchain data without ever trusting each other. The cryptographic hash allows each peer to sum up the data and confirm that it was sent and received as intended.

Built on top of the network topography established by the peer to peer network is a gossip messaging protocol. This protocol determines the way messages are exchanged between each peer on the p2p network as to ensure that every node will receive a copy of messages sent on the network, while minimizing message repeats (echos). When new transactions are created to insert into the blockchain, a node will send this transaction as a gossip message to the multiple peers it is connected to, and they will in turn forward it to their own peers and this continues until the entire network has received the message. The new transaction will be validated and then added to the temporary transaction pool by each actor, where it will stay indefinitely until it is confirmed by a confirmation block. Once confirmed, it is removed from the transaction pool and appended to eternity into the final blockchain.

### SUMMARY

According to one aspect, there is provided a method for validating execution of a smart contract, the method comprising:

storing/receiving the smart contract within a blockchain having at least one first order block/transaction, the smart contract having a set of electronically-defined contract clauses, each cause being defined by at least one satisfaction value, the combination of the satisfaction values of the set of contract clauses having a satisfaction hash value for the smart contract;

reading a set of one or more electronically-stored second order transactions each having a subset of one or more execution values;

selecting, from the set of electronically-stored second order transactions, a subset of transactions corresponding to the contract clauses of the smart contract;

determining an execution hash value of the combination of execution values of the subset of transactions;

determining the smart contract as being fully executed if the execution hash value of the combination of execution values of the subset of transactions matches the satisfaction hash value of the smart contract.

According to another aspect, there is provided a method of validating identity of a party to a blockchain transaction, the method comprising publishing a party initialization block within a blockchain, the party initialization block comprising:

a unique identifier associated to a given party;

a first public key derived from a first private key associated to the party; and

a second public key derived from a second private key associated to the party.

According to another aspect, there is provided a computer-implemented system for validating execution of a smart contract, the system comprising at least one data storage device and at least one processor coupled to the at least one storage device, the at least one processor being configured for:
storing the smart contract within a blockchain having at least one first order block, the smart contract having a set of electronically-defined contract clauses, each clause being defined by at least one satisfaction value, the combination of the satisfaction values of the set of contract clauses having a satisfaction hash value for the smart contract;
reading a set of one or more electronically-stored second order transactions each having a subset of one or more execution values;
selecting, from the set of electronically-stored second order transactions, a subset of transactions corresponding to the contract clauses of the smart contract;
determining an execution hash value of the combination of execution values of the subset of transactions; and
determining the smart contract as being fully executed if the execution hash value of the combination of execution values of the subset of transactions matches the satisfaction hash value of the smart contract.

According to yet another aspect, there is provided a computer-implemented system for validating identity of a party to a blockchain transaction, the system comprising at least one data storage device and at least one processor coupled to the at least one storage device. The at least one processor is configured for publishing a party initialization block within a blockchain, the party initialization block within a blockchain comprising:
a unique identifier associated to a given party;
a first public key derived from a first private key associated to the party; and
a second public key derived from a second private key associated to the party.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 illustrates a diagrammatic representation of a data structure for storing a smart contract according to one example embodiment;

FIG. 2 illustrates a diagrammatic representation of a data structure of transaction event entries according to one example embodiment;

FIG. 3 illustrates a schematic diagram of a first order blockchain for storing the electronically-defined contract clauses and a second order blockchain for storing electronically defined transaction event entries according to one example embodiment;

FIG. 4 illustrates a visual representation of various states and statuses of a transaction derived from electronically stored transaction event entries according to one example embodiment;

FIG. 5 illustrates a visual representation of a first binary hash tree of satisfaction values and a second binary hash tree of corresponding execution values according to one example embodiment;

FIG. 6 illustrates a visual representation of a visual representation of an expanded binary hash tree that corresponds to multiple satisfaction values of a contract clause according to one example embodiment;

FIG. 7 illustrates a flowchart of the operational steps of a method for validating execution of a smart contract according to one exemplary embodiment;

FIG. 8 illustrates a schematic diagram of the operational modules of a computer-implemented execution validation system according to one example embodiment;

FIG. 9 illustrates a visual representation of contract clause snippets used to build a machine verifiable smart contract that can also be built and expressed using natural language, according to one example embodiment;

FIG. 10A illustrates a visual representation of composite layers of contract clause snippets and amendments and a presentation of the smart contract generated from “flattening” the composite layers;

FIG. 10B illustrates a visual representation of an example of text overlays arranged in layers and stored in blocks;

FIG. 10C illustrates a visual representation of the progression of a smart contract as amendments are made by modifying a clause or adding a clause;

FIG. 11A illustrates a visual representation of contract snippets stored within a chain of blocks according to one example embodiment;

FIG. 11B illustrates a visual representation of snippets referencing other already stored snippets according to one example embodiment;

FIG. 12A illustrates a visual representation of a party initialization block and a transaction block of a blockchain having identity validation according to an example embodiment;

FIG. 12B illustrates a visual representation of a party initialization block, an authentication update block and a subsequent transaction block of a blockchain according to an example embodiment; and

FIG. 13 illustrates a visual representation of blocks of a blockchain implementing a multi-signature application according to an example embodiment.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art, that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

“Smart contract” herein refers to a set of smart contract clauses that are stored in first order blocks of a computer-implemented blockchain.

“Contract clause” of a smart contract herein refers to electronically stored coded rules that define execution obligations. Fulfillment of a contract clause of the smart contract can be automatically verified within a computer system by determining that one or more satisfaction values defined by the contract clause are present in execution values of transaction derived from stored transaction event entries.

“Transaction event entry” herein refers to a data entry storing information pertaining to a real-life event that has occurred, such as an action performed by a party. A transaction event entry may store one or more electronically-defined event components, such as an electronically-defined properties of the event and/or an informational variable and a value of the variable.

“Transaction” herein refers to the information derived or determined from one or more event components from one or more transaction event entries. More particularly, one or more execution values can be determined or derived from the one or more event components and each transaction consists of a subset of the execution values.

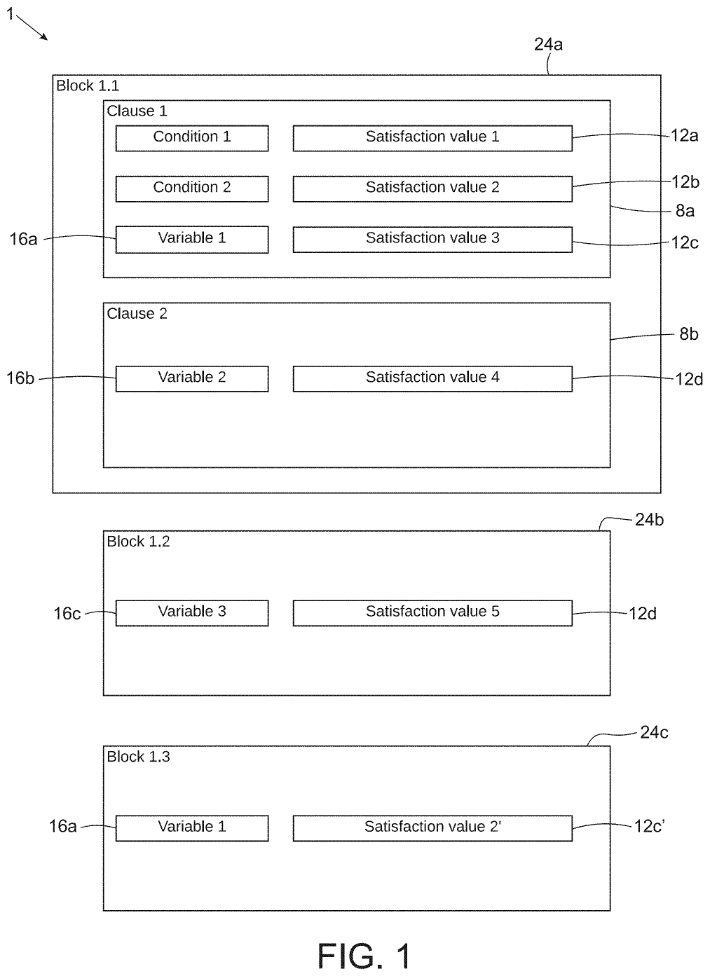

Referring now to FIG. 1, therein illustrated is diagrammatic representation of a data structure for storing a smart contract 1 according to one example embodiment. The smart contract 1 is electronically stored as one or more contract instances. Each contract instance includes at least one electronically-defined contract clause. Each contract clause is further defined by at least one electronically-defined satisfaction value. Each satisfaction value corresponds to a value that is indicatable by a possible execution value determinable from stored transaction event entries that track real-life events. The presence of an execution value determined from transaction event entries being equal to a given satisfaction value of a given contract clause indicates fulfillment of a portion of the contract clause corresponding to that satisfaction value. That is, the satisfaction values of a contract clause define the target values for considering that the contract clause is fulfilled.

A satisfaction value can define the presence of a condition that is indicatable by a possible execution value. In such a case, the satisfaction value simply defines the condition that must be present and the satisfaction value is met if the condition is true.

A satisfaction value can define a variable and a target value for the variable. The satisfaction value is met if an execution value has the given variable and that variable has the target value. The variable can be a piece of electronic information having a particular type and a variable value. Alternatively, the variable can be a type of electronic document and its value is the electronic information indicated within the electronic document. For example, a variable can be any one of:
a numerical value (real number, integer, floating point, or other)
Date/time;
Character string;
Monetary amount
Audio-visual digital file (ex: digital image, audio file or video);
Digital document;
Digital cryptographic signature;
Web address (IP address, URL, etc.)
Computer program;
Programmatic script;
Data block
Any other type of computer data may be validated digitally;
Any other type of computer data that may be validated by a human user and confirmed using a digital signature of the human.

In the example illustrated in FIG. 1, a first instance 4a of the smart contract 1 has a set of two electronically-defined contract clauses 8a and 8b. The first clause 8a (“clause 1”) defines two satisfaction values 12a and 12b. First satisfaction value 12a is of the condition type and the satisfaction value simply defines the target condition that is to be present in execution values derived from transaction event entries in order for the first clause 8a to be considered executed. Second satisfaction value 12b IS also of the condition type. Third satisfaction value is of the variable type, in which case the variable 16a to be identified in execution values derived from transaction event entries is defined and the satisfaction value 12c of that variable 16a is also defined.

The second clause 8b (“clause 2”) defines a single satisfaction value 12d, which is further defined by a second variable 16b to be identified in execution values derived from transaction event entries and the target value of that variable 16b.

Contract clauses defined in the smart contract 1 may be amended over time. For example, an amendment may be made in the form of an addition of a new clause or a modification to an existing clause. It will be understood that the smart contract is initially defined by a set of one or more root contract clauses and amendments can be made to this set over time. It will be further understood that the amendment to the set of contract clauses causes the smart contract to have an updated set of electronically defined contract clauses.

Continuing with the example illustrated in FIG. 1, a first amendment in the form of an addition of a new clause is provided. The amendment defines a new clause having a third variable 16c and its satisfaction value 12d. This new clause 8c, being a third clause of the exemplary smart contract, causes the set of clauses defining the smart contract to be updated.

The example of FIG. 1 also illustrates a second amendment in the form of a modification to an existing clause of the smart contract. The amendment defines a change to the first clause 8a by defining a modified satisfaction value 12c′ for the first variable 16a. This brings a further amendment to the set of clauses forming the smart contract.

The smart contract described herein according to various example embodiments can be stored within a blockchain. According to such example embodiments, the blocks storing the smart contract correspond to first order blocks of the blockchain. These blocks are to be distinguished from second order blocks used to store transaction event according to various exemplary embodiments, as described elsewhere herein.

For example, an initial set of one or more first order blocks of the blockchain can store root contract clauses. One or more amendments to any set of current contract clauses forming the smart contract can be stored in subsequent first order blocks appended to previous blocks of the blockchain. Each amendment to the smart contract can be stored by storing the entire amended contract within appended blocks. Alternatively, each amendment to the smart contract can be stored by storing the incremental change to the appended block. For example, in FIG. 1, the root contract clauses 8a and 8b forming the first instance of the smart contract are stored in a first first-order block 24a. The first amendment is stored in a second first order block 24b that indicates only the new contract clause 8c. The second amendment is stored in a third first order block 24c that indicates only the amendment to the first clause 8a. The electronically stored data representing the contract clauses may be distributed across first-order blocks of the blockchain according to other methods known in the art.

Whether the smart contract stored in the first-order blocks has been fully executed (i.e. the satisfaction values of all of the contract clauses have been met) or partially executed is determined based on information stored externally of the first-order blocks. Accordingly, the smart contract is considered to be substantially immutable in that the data content stored in the first-order blocks to define the smart contract remain unchanged while information being generated to track real-world events for determining whether the smart contract is executed (fully or partially) can be evolving over time. It will be understood that any changes to the first-order block would cause an amendment to the smart contract while evolving information about real-world events does not change the terms of smart contract.

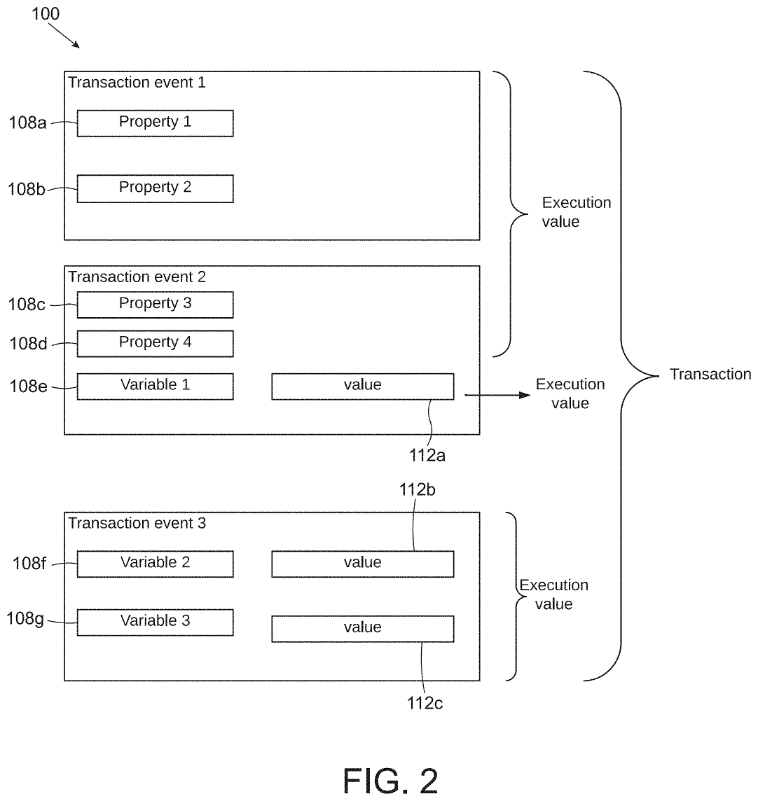

As described elsewhere herein, the data providing information about real-world events can be stored in a set of transaction event entries, which may be further stored in a set of second order blocks of a blockchain. Referring now to FIG. 2, therein illustrated is diagrammatic representation of a data structure for storing transaction event entries. Execution of values can be determined or derived from the electronically-stored transactions event entries. Sets of one or more execution values can define a transaction being tracked within the event entries. It will be appreciated that the properties of an ongoing transaction can be evolving over time as new real-world events occur and are stored within transaction event entries. The properties of a transaction can be defined by execution values determined from information provided by the transaction events. Occurrences of new real-world events can change execution values, thereby changing the parameters of the ongoing transaction.

The example illustrated in FIG. 2 illustrates a series 100 of transaction event entries that can be stored such that the event entries, when combined, can represent an evolving transaction. Each event entry represents an event that has taken place in the real world. Each transaction event entry can include one or more event components that store information about the transaction event.

For example, a first transaction event entry 104a includes a first event component 108a of the property type and a second event component 108b of the property type. The first and second event components 108a and 108b of the property type define properties of the event that has occurred.

A second exemplary transaction event entry 104b includes a third event component 108c of the property type, a fourth event component 108d of the property type and a fifth event component 108e of the variable type. The variable type can correspond to a variable type that is defined within a smart contract clause. The variable type event component includes a value 112a of the given variable.

A third exemplary transaction event entry 104c includes a sixth event component 108f of the variable type and a seventh event component 108g of the variable type. Each of event components 108f and 108g have a respective value 112b and 112c.

One or more event components across one or more stored transaction event entries can define an execution value. The execution value can have a value that matches the satisfaction value of one of the contract clauses defined in a smart contract stored within the first-order blocks.

For example, one or more properties across one or more transaction event entries can indicate the presence of a condition resulting from real-world events, which gives an execution value. The presence of the condition, and thereby the presence of the execution value, being indicated by the transaction event entries can be used to determine whether a contract clause is satisfied based on whether the execution value matches the satisfaction value for that clause.

One or more properties across one or more transaction events can indicate a variable having a particular value, which also gives an execution value. The value of the variable being indicated in the transaction events can also be used to determine whether a contract clause is satisfied based on whether the value of the variable defined from the execution value matches the satisfaction value for that clause.

An execution value can be equal to the value defined in an event component of a transaction event entry. An execution value can also be determined or derived from the value defined in one or more event components across one or more transaction event entries.

As described elsewhere herein, the stored transaction event entries store information that represent events that take place in the real world. One or more execution values define a transaction being tracked from storing the transaction event entries. A transaction is therefore a subset of one or more execution values that correspond to one or more contract clauses defined in a smart contract, such that a comparison of the execution values with the satisfaction values of the contract clauses can be used to determine whether the contract clauses are satisfied. Accordingly, appropriately determining execution values to form transactions can be used to determine whether the smart contract as a whole has been satisfied.

The electronically-stored transaction event entries described herein according to various example embodiments can be stored within at least one blockchain. Each transaction event entry can be stored in one or more blocks of the blockchain according to methods known in the art. For example, and as illustrated in FIG. 2, each transaction event entry is stored within a respective block.

The transaction event entries can be stored within at least one blockchain that is independent of the blockchain of first order block storing the smart contract. That is, the blockchain formed of the first order blocks is independent of the at least one other blockchain storing the transaction event entries.

Alternatively, the transaction event entries can be stored within the same blockchain as the first order blocks. In such a blockchain, the blocks used to store the smart contract are logically distinct from the blocks storing the transaction event entries. This allows for building the smart contract from the first order blocks separately from determining execution values and deriving transactions from blocks storing the transaction event entries.

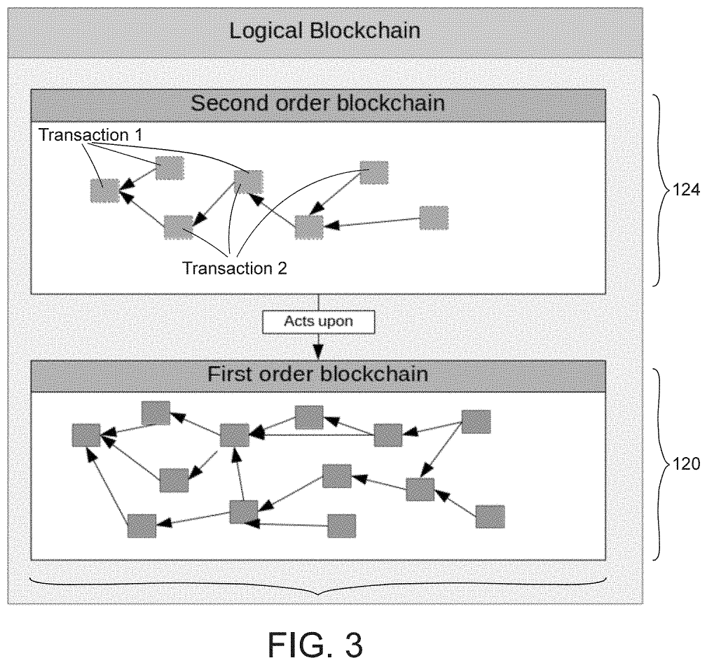

Referring now to FIG. 3, therein illustrated is a schematic diagram of a first order blockchain for storing the electronically-defined contract clauses and a second order blockchain for storing electronically-defined transaction event entries. A first blockchain 120 acts a first order blockchain that stores one or more smart contracts. A second set of blocks 124, which can form a second blockchain stores the transaction event entries. Transactions are second order “meaning” or subsets of execution values determined or derived from the entries stored in blocks 124. In the illustrated example two transactions (transactions 1 and 2) are determined from the stored transaction event entries. Execution values of the transactions are compared with corresponding satisfaction values for the first order blockchain to determine whether a given smart contract is satisfied.

It will be understood that one or more additional orders of data (ex: third order, fourth order, etc.) can also be stored. Such higher orders of data can be stored within other blockchains or within a same blockchain (ex: same as first blockchain 120 or second blockchain 124) using distinctive blocks. For example, instead of storing information directly within event components of the second order transaction event entries, such information can be stored as higher order data and the event components of the second order transaction event entries can link to the higher order data.

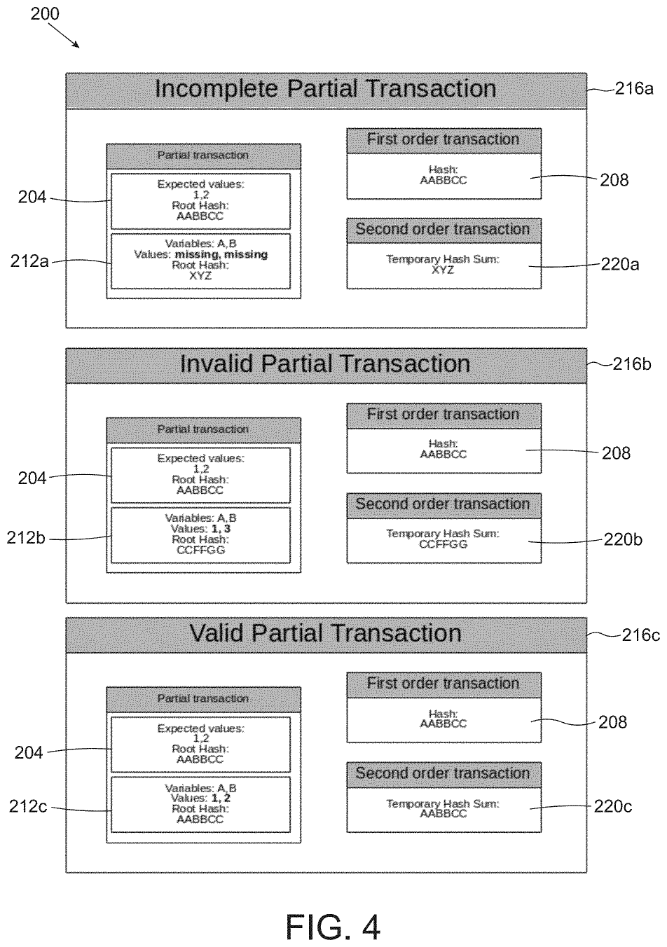

Referring now to FIG. 4, therein illustrated is a visual representation 200 of various states and statuses of a transaction derived from electronically stored transaction event entries and the comparison with satisfaction values of a corresponding contract clause of a smart contract according to one example embodiment.

The satisfaction values for the given contract clause are indicated in the example as “Expected values”. In the illustrated example, these are variables “A” and “B”, having the values “1” and “2” respectively. These are diagrammatically represented in box 204. That is, a transaction derived from transaction events that includes execution values having a variable “A” of value “1” and variable “B” of value “2” (thereby matching the defined satisfaction values) will indicate that the contract clause has been fulfilled.

The contract clause is defined by a given satisfaction hash value, which corresponds to a hash value generated by applying a hashing function to satisfaction values defined for the contract clause.

According to one example embodiment, the satisfaction values are stored in a binary hash tree structure and the satisfaction hash value represents the hash value at a given level of the binary hash tree corresponding to the contract clause and obtained by appropriately hashing all satisfaction values that are children to that given level. In the illustrated example, the satisfaction hash value 208 for the given clause is “AABBCC”. It will be appreciated that the satisfaction has value 208 is determined as if execution values having the same satisfaction values are present in the transaction event entries. It will be further appreciated that the binary hash tree structure for storing satisfaction values is well suited for storing the satisfaction values of the smart contract within a blockchain.

Current execution values determined from transaction event entries that have been generated thus far are also illustrated. The execution values of a transaction determined from transaction event entries and to be compared to the satisfaction values of a given contract clause are arranged in a binary hash tree arrangement to have the same logical arrangement as the binary hash tree of the satisfaction values of that contract clause. Therefore, where the execution values match the satisfaction values, the same hash value will be generated from the binary hash tree for the satisfaction values and from the binary hash three for the execution values.

In a first state of an exemplary transaction of FIG. 4, as indicated in table 216a, execution values derived from transaction event entries indicate that the values for variable “A” and variable “B” are missing, as indicated in box 212a. The missing values generates an execution hash value of “XYZ” (box 220a). Since the satisfaction hash value does not match the execution hash value, the contract clause is determined as being non-satisfied.

Missing values can correspond to a situation where no real-world events have occurred that would cause storing transaction event entries indicating variables having these values. For example, the satisfaction values defined in the contract clause can consist of variable “A” as a photo ID and a satisfaction value “John Smith” and variable “B” being a pin code and a satisfaction value of “ABC123”. The corresponding transaction is a subset of execution values determined from the transaction event entries to indicate the value of a received photo ID and a received pin code. In the incomplete partial transaction state 216a, a photo ID and a pin code have not yet been provided in real world-event(s) and hence the values are missing.

In a second state of the same transaction, execution values of the transaction now have the value “1” for variable “A” and value “3” for variable “B”. This generates an execution hash value of “CCFFGG” (boxes 212b and 220b). Since this execution hash value does not match the satisfaction hash value “AABBCC”, the transaction in its second state 216b is considered to not have fulfilled the given contract clause. For example, additional transaction event entries are now stored to reflect real world events in which a user provided the photo ID for “John Smith” but did not provide the correct pin code. The current state of the transaction reflects the execution values determined from these additional event entries.

In a third state of the same transaction, execution values of the transaction now have the value “1” for variable “A” and value “3” for variable “B”. This generates an execution hash value of “AABBCC” (boxes 212c and 220c). Since this execution hash values matches the satisfaction hash value “AABBCC”, the transaction in its third state 216c is considered to have fulfilled the given contract clause. For example, additional transaction event entries are now stored to reflect real world events in which a user provided the photo ID for “John Smith” and also provided the correct pin code.

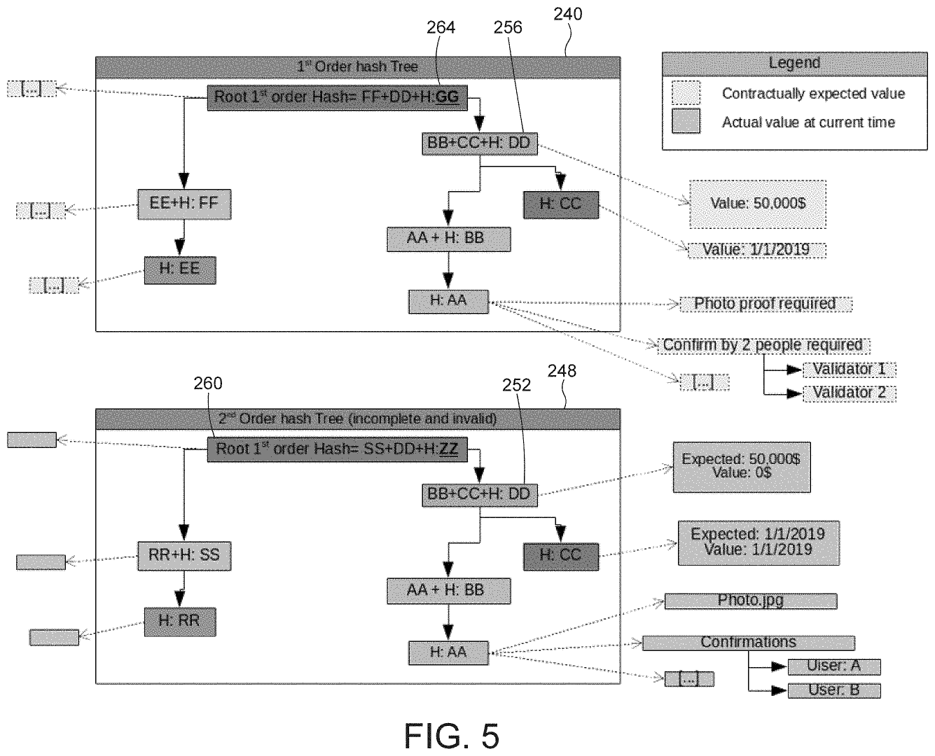

Referring now to FIG. 5, therein illustrated is a visual representation of a first binary hash tree 240 of satisfaction values for a group of contract clauses (ex: a clause and various subclauses) and a second binary hash tree 248 of corresponding execution values for determining whether the group of clauses are satisfied. Satisfaction values for the right side branch of the first binary hash tree 240 are defined. For example, the satisfaction values of the right sided branch of first binary hash tree 240 corresponds to the portion of a smart contract illustrated in the example of FIG. 1 as follows:

| | |
|---|---|
| Condition 1 | Cost less than $50 000 |
| Condition 2 | Work complete by Jan. 1, 2019 |
| Variable 1′ | Photo of completed work (as updated in |
| | amendment) |
| Variable 2 | Confirmation of validator 1 |
| Variable 3 | Confirmation of validator 2 |

It will be appreciated that each node at a given level of the binary hash tree defines a respective hash value, which is the concatenation of hash values generated by children nodes one level down from that node and the hash value from the satisfaction value for that node. This allows determining at each level whether the satisfaction values for that level and all children nodes are present in execution values of one or more transactions.

Second binary hash tree 248 has execution values corresponding to the satisfaction values and arranged in the same binary hash tree arrangement. In the illustrated example, the right side branch has execution values from one or more transactions. Moreover, these execution values are equal to the satisfaction values in the right side branch of the first binary hash tree 240. Accordingly, the intermediate node 252 for the right side branch of the second-order binary hash tree 248 has the same hash value “BB+CC+H:DD” as the corresponding node 256. However, since the execution values in the left hand side branch of second-order binary hash tree 248 does not yet match the left hand side branch of the first-order binary hash tree 240, the root execution hash value 260 for the entire second-order binary hash tree 248 does not match the satisfaction hash value 264 for the first-order binary hash tree 240.

The transaction event entries that generates the execution values defining a transaction that eventually satisfies the satisfaction values of the right-hand branch of the first-order binary hash tree 240 can be represented by exemplary transaction event entries of FIG. 2, as follows:

Transaction event 1 (date Dec. 2, 2018)

| | |
|---|---|
| Property 1 | Completion of sub-task ½ of task. |
| Property 2 | Cost of sub-task ½ is $20 000. |

Transaction execution values after event 1:

| | |
|---|---|
| Condition 1 | Yes |
| Condition 2 | No |
| Variable 1′ | Missing |
| Variable 2 | Missing |
| Variable 3 | Missing |

Transaction event 2 (date Dec. 6, 2018)

| | |
|---|---|
| Property 3 | Completion of sub-task 2/2 of task. |
| Property 4 | Cost of sub-task 2/2 is $23 000. |
| Variable 1 | Photo of completed work. |

Transaction execution values after event 2:

| | |
|---|---|
| Condition 1 | Yes |
| Condition 2 | Yes |
| Variable 1′ | Photo of completed work |
| Variable 2 | Missing |
| Variable 3 | Missing |

Transaction event 3 (date Dec. 19, 2018)

| | |
|---|---|
| Variable 1 | Confirmation of validator A |
| Variable 2 | Confirmation of validator B |

Transaction execution values after event 3:

| | |
|---|---|
| Condition 1 | Yes |
| Condition 2 | Yes |
| Variable 1′ | Photo of completed work |
| Variable 2 | Confirmation of validator A |
| Variable 3 | Confirmation of validator B |

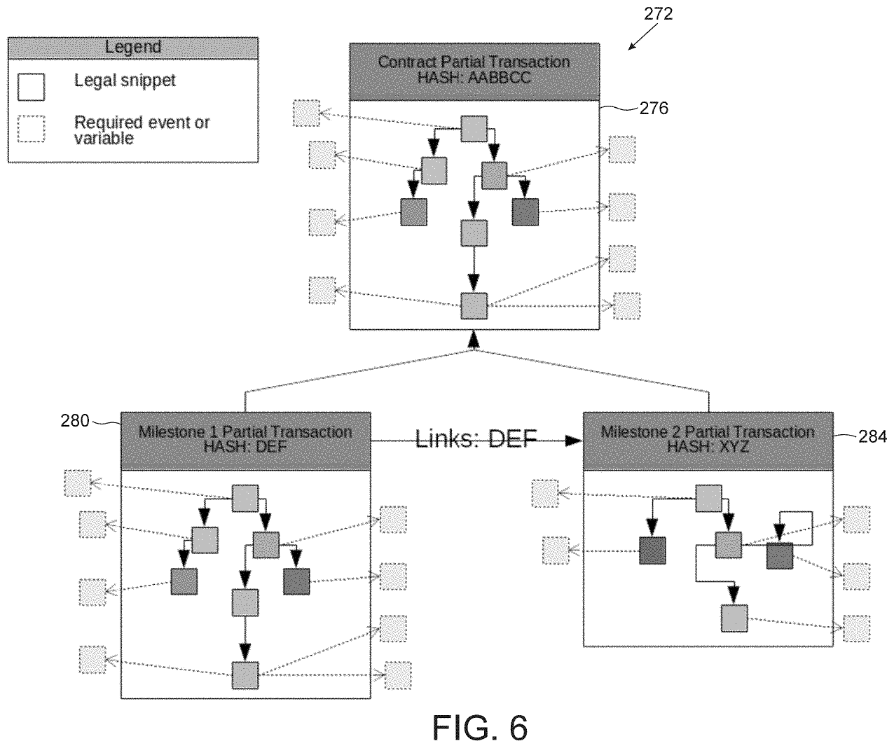

Referring now to FIG. 6, therein illustrated is a visual representation of an expanded binary hash tree 272 that can correspond to multiple satisfaction values of a contract clause according to one example embodiment. For example, a given contract clause can have a set of top level satisfaction values. These top-level satisfaction values are represented in the top-level tree 276. The given contract clause can also have lower-level satisfaction values that correspond to sub-clauses of that contract clause. In the illustrated example, each sub-clause represents a milestone or partial transaction. First sub-clause is represented by first lower-level tree 280 and second sub-clause is represented by second lower-level tree 284. Each lower-level tree has a respective satisfaction hash value (“DEF” for first tree 280 and “XYZ” for second tree 284). An execution hash value of one or more transactions from the stored transaction event entries matching the first satisfaction hash value for the first lower-level tree 280 indicates that the first sub-clause is satisfied (first milestone complete). Similarly, an execution hash value of one or more transactions from the stored transaction event entries matching the second satisfaction hash value for the second lower-level tree 284 indicates that the second sub-clause is satisfied (second milestone complete). It will be appreciated that completion of either one of the sub-clauses can be determined without having to determine that the whole clause has been fulfilled. Furthermore, by combining the execution hash values for both lower level trees with an execution hash value for the top-level tree, it can be determined that the entire clause has been executed.

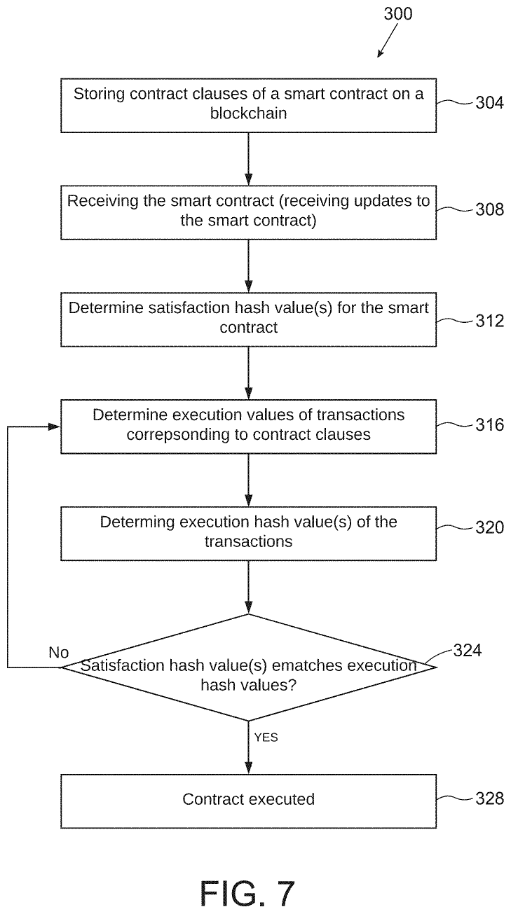

Referring now to FIG. 7, therein illustrated is a flowchart of the operational steps of a method 300 for validating execution of a smart contract according to one exemplary embodiment.

At step 304, the smart contract is generated. Various exemplary methods for generating the smart contract are described elsewhere herein. Generating the smart contract can include iteratively amending the smart contract (modifying or adding new contract clauses) as described elsewhere herein. It will be understood that the smart contract can be generated on a system that is separated from the system carrying out the method for validating execution of the smart contract and the step of generating the smart contract may be considered as not being part of the method for validating execution of the smart contract.

At step 308, the smart contract to be analyzed to determine execution thereof is received. The received smart contract corresponds to a current version of the smart contract, which can be the initial version or a currently amended version of the smart contract.

At step 312, satisfaction hash values for the smart contract are determined. This may include determining a global satisfaction hash value for all clauses (and all satisfaction values) of the smart contract. This may also include determining intermediate satisfaction hash values for individual clauses or sub-clauses within the smart contract.

At step 316, execution values forming transactions corresponding to the satisfaction values of the given smart contract are determined or derived from transaction event entries. As described elsewhere herein, the transaction event entries may be stored within second-order blocks of a blockchain.

At step 320, the execution hash values for the transactions corresponding to the satisfaction values are determined. As described elsewhere herein, execution values can be arranged in a binary hash tree arrangement in a way corresponding to the binary hash tree of satisfaction values. A global execution hash value can be determined. Intermediate execution hash values corresponding to individual clauses or sub-clauses can also be determined.

At step 324, the satisfaction hash value(s) from step 316 are compared to execution hash values(s) from step 320. This allows determining whether the smart contract, as a whole, has been executed. The determining can also indicate that the smart contract is partially executed and also identify those clauses that have been executed and other that have not been executed. If the smart contract has been fully executed, the method proceeds to step 328 to indicate that the smart contract has been executed.

If the smart contract is not executed (or only partially executed), the method returns to step 316 to update execution values for the transactions based on newly stored transaction event entries. Alternatively, according to some exemplary embodiments, the method may return to step 308 to receive an updated version of the smart contract.

The blockchain is by nature a series of immutable blocks, linked and secured by a chain of cryptographic hashes. Various exemplary embodiments described herein provides a mechanism for defining an immutable computer-implementable smart contract. Moreover, the execution status of the smart contract can evolve over time by tracking real-world events in transaction event entries and deriving execution values of transactions corresponding to the smart contract. That is, the execution values of the transactions can be changing over time. Accordingly, the transactions are a second-order meaning that is separate from the immutable smart contract.

With this approach, a structurally immutable and cryptographically enforced contract can be built while still permitting conditions and variables to be modified over time by events with retroactive modifications to partial transactions, thereby progressively confirming the execution of contract. This can allow for the creation of complex smart contracts, with multiple sets of milestones in a fully immutable manner. This approach further allows the ability to track the status of the transactions over time as a second order meaning (ex: transactions can be incomplete, partially complete or fully executed) without breaking the structural and cryptographic integrity of the first-order blockchain storing the immutable smart contract.

According to various example embodiments described herein, a concept of first-order smart contract and second-order transactions is introduced. Both the smart contract and the transactions can be represented within a blockchain(s). First order contract clauses are stored to be fully immutable in the blockchain and linked between each other through permanent cryptographic hashes. Second order transactions (partial transactions) are a mutable second level of interpretation independent of the first order contract clauses. For example, while transaction event entries representing real-world events may be stored in an immutable manner in a blockchain, the execution values that define the transactions (having a second-order meaning) are derived from the event entries. As such, the execution values and the status of the transactions are mutable. Target satisfaction values of the smart contract required to show execution of the smart contract can be provided over time through confirmed second order transactions having execution values matching the satisfaction values. Completed transactions can then be retroactively written into the first-order blockchain without breaking the hash relationships between blocks and the cryptographic integrity of first-order blockchain storing the smart contract.

As described elsewhere herein, real-world events can be stored in an immutable manner within a chain of blocks in the form of transaction event entries. As also described elsewhere herein, such as within the example of FIG. 4, the transaction event entries allow for deriving or determining execution values that further define a state of a transaction. As new event entries are appended, the state of the transaction is also updated. Such mutable transactions, also referred to herein as partial transactions, may be stored as transaction entries. Such entries can include memory slots for storing specific execution values derived or determined from the transaction event entries. Alternatively, the memory slots can store specific hash values generated from the execution values. The execution value (or execution hash values) stored in the memory slots can further be stored temporarily within the execution validation system. Alternatively, these values can be stored within a blockchain for tracking the state of the partial transactions over time as new events occur. Each set of execution values (or execution hash values) stored in the memory slots at any given time defines a state of the partial transaction.

Accordingly, the electronically stored smart contract can be thought of as a lower ‘N’-th order transaction (ex: N=1 in the examples described herein for first order). The contract clauses of the smart contract define the execution values (in the form of satisfaction values) that need to be determined or derived and further indicate the memory slots to be assigned in the transaction entries for storing partial transactions. The partial transactions defined by the execution values determined or derived from event entries and tracked within the memory slots of the transaction entries can be thought of ‘N+1’-th order transaction (ex: N+1=2 in the examples described herein for second order). As new events occur and the execution values change, the state of the partial transaction will also change. It was observed that the append-only, immutable nature provided by the cryptographical assurances of a blockchain is well suited for defining contractual relationships. However, mutability may be desired in determining execution of a contract because execution state of the contract changes—the execution state in time is mutable. One solution is to create an entry in the blockchain each time the status of a transaction is changed (ex: as a result of a real-world event). While this provides immutability, this solution produces superfluous repetition of transaction data on the blockchain, which uses more disk space and bandwidth. Various exemplary embodiments described herein overcomes this drawback while preserving immutability of the blockchain and allowing for mutability in execution values of transactions being tracked.

Various exemplary embodiments described herein makes use of hash values. Satisfaction hash values are generated from the first-order smart contract and represent the hash value that will be present when the smart contract is considered as being fulfilled. Execution hash values are generated for execution values of transactions derived from the second-order transaction event entries. Incomplete, incorrect or invalid execution values produces execution hash values that do not match the satisfaction hash value, thereby indicating that the contract has not been executed. As mentioned elsewhere herein, the status of the transactions can be modified over time. As new real-world events occur, the execution values of the transactions evolve until the execution hash values match the satisfaction hash values. At this point, the smart contract (a clause of the contract or a subclause) is considered executed. Otherwise, if the hash values are different, the contract is considered to not be fully executed.

In terms of security, by storing transaction event entries within a second-order blockchain according to various exemplary embodiments, it would become very difficult to tamper with the second order transaction execution values that allow for determining that a contract has been executed. Although the execution values derived from the event entries are mutative in time, these evolving values are supported by the cryptographic validity of the stored transaction event entries, which are immutable. It is by replaying the transaction event entries that the execution values of the transactions will appear mutative in time. Therefore, the transaction event entries validate the evolution of execution values of the transactions.

After compiling the contract to an intermediary compressed and binary format which contains all information pertaining to the contract and required to interpret it, contract clauses of the smart contract can be understood as being target partial transactions inserted in the first order blockchain. The smart contract therefore represents a complete structure of all the first order target transactions that will be required for the contract completion. Completion occurs when execution values define real-world transactions matching the target transactions. Stored target transactions can include multiple chains of milestones, each dependent on the success of their predecessor to come into scope. If a contract is perpetual, then later milestones may be added in a dynamic manner after the successful completion of a previous milestone.

These first order target transactions (i.e. contract clauses) link to each other using the ideal hash and are added to the blockchain to remain there immutable in the first order. These target transactions will all be partial transactions, and thus provide meaning at the second order.

Various example embodiments described herein for defining smart contracts and determining or deriving execution values of transactions allows for computer-implemented interpretation and validation of the execution of the smart contract.

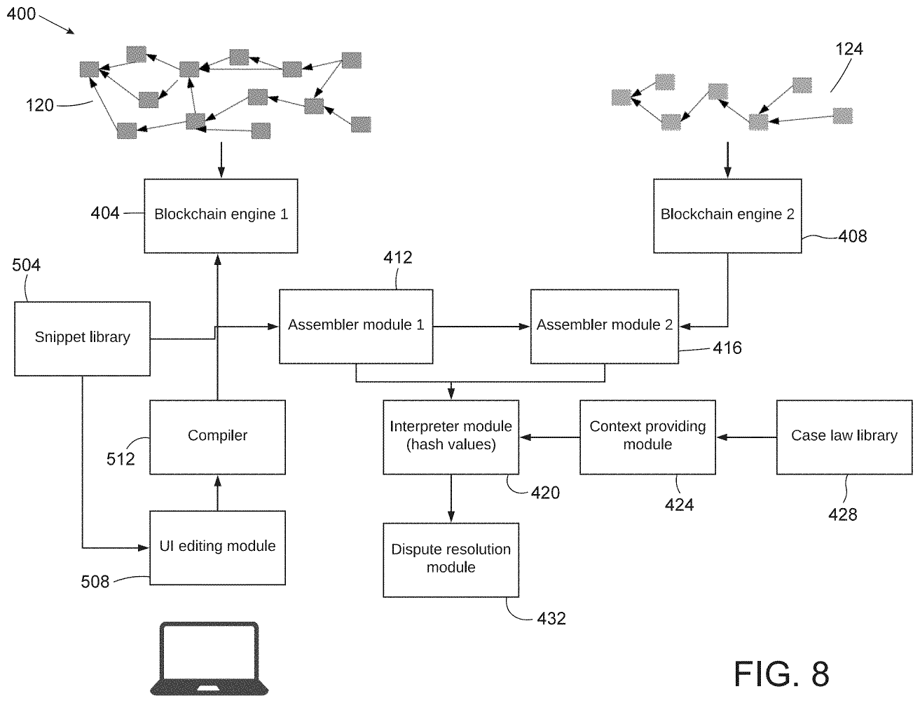

While examples described herein for defining and validating of smart contracts and contract clauses is readily applicable for determining satisfaction of execution obligations between parties, it will be understood that systems and methods described herein may be applicable in any use case that involves tracking the presence of a set of one or more conditions and/or one or more variable values. The condition(s) and/or variable value(s) are defined in the first order transaction while events are tracked to allow building the second order transactions, wherein the first order clauses and the second order partial transactions can be stored in one or more blockchains. For example, it may be used to track the status and results within a review and commentary system, such as, within an e-commerce platform. Referring now to FIG. 8, therein illustrated is a schematic diagram of the operational modules of a computer-implemented execution validation system 400 for validating execution of a smart contract. The system 400 described herein are presented as a series of computer-implemented modules.

The system described herein are described herein as modules that may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, personal computer, network of interconnected computers, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language.

As described elsewhere herein, a computer-implemented first-order blockchain 120 stores contract clauses of one or more smart contract within first order blocks. As also described elsewhere herein, a computer-implemented second-order blockchain 124 may be provided to store transaction event entries within second-order blocks.

The system 400 includes a first blockchain engine 404 that is configured to retrieve and interpret electronic data stored on the first blockchain 120. Data retrieved can contain data pertaining to stored contractual clauses of one or more smart contracts. The first blockchain engine 404 can also be configured to write data blocks to the first blockchain 120. Written data can contain data pertaining to amendments to contractual clauses of one or more smart contracts.

The system 400 includes a second blockchain engine 408 that is configured to retrieve and interpret electronic data stored on the second blockchain 124. Data retrieved can contain data pertaining to stored transaction event entries. The second blockchain engine 408 can also be configured to write data blocks to the second blockchain 124. Written data can contain data pertaining to new transaction event entries tracking real-world events. According to various exemplary embodiments, various third parties that transact with one another can write transaction event entries to the second order blockchain.

The system 400 includes a first contract assembler module 412 that is configured to extract a relevant smart contract from the data retrieved from the first-order blockchain 120 by the first blockchain engine 404. The first contract assembler module 412 can identify from the retrieved blocks those specific blocks that store data pertaining to a given smart contract. Where a smart contract is stored across multiple blocks, such as due to amendments (modifications to clauses or newly added clauses) made over time, the first contract assembler module 412 is operable to assemble portions of the smart contract to generate the full smart contract for validation.

The system 400 includes a second contract assembler module 416 configured to extract relevant transaction event entries that correspond to the relevant smart contract extracted by the first contract assembler module 412. The second contract assembler module 416 receives the smart contract assembled by the first contract assembler module 412 and identifies from the data retrieved from the second-order blockchain 124 those specific blocks that store transaction event entries pertaining to that smart contract. Pertinent transaction event entries can be those storing information about real-world events that allow for determining or deriving execution values of transactions that correspond to contract clauses of the smart contract. As described elsewhere herein, the execution values allow for determining whether the smart contract has been satisfied.

The system 400 includes an interpreter module 420 that is configured to automatically determine whether the smart contract has been executed based on the information stored in the transaction event entries. The interpreter module 420 can extract the satisfaction values of the smart contract assembled by the second contract assembler module 416. Where the satisfaction values are arranged in one or more binary trees, the interpreter module 420 can generate one or more satisfaction hash values (ex: global satisfaction hash value for the entire contract and/or partial hash value for contract clauses or sub-clauses) from the satisfaction values.

The interpreter module 420 can also determine or derive execution values from the transaction event entries extracted by the second contract assembler module 416. As described elsewhere herein, the execution values can be determined or derived from one or more event components. Subsets of the execution values correspond to contract clauses of the smart contract.

According to one example embodiment, and as illustrated in FIG. 8, the determination or derivation of execution values can be based on inputs from a context providing module 424 that is configured to provide context for determining or deriving execution values from event components of transaction event entries. The context may be based on a rules library 428 that stores electronically-defined rules that further define how event components should be interpreted based on legal statutes and/or case law. Rules library 428 may be updated over time based on changes in the law. An example of an interpretation rule can be how to treat a deadline falling on a weekend or holiday (ex: deadline is the weekday before, or is extended to the next weekday). Another example can be sets of building codes used to determine whether a building meets the building codes.

The interpreter module 420 is further configured for comparing satisfaction values of the assembled smart contract with execution values determined or derived from the transaction event entries and to determine from the comparison whether the smart contract has been executed (or whether at least portions of the smart contract has been executed). As described elsewhere herein, execution values are compared with corresponding satisfaction values and if both sets of values match then the smart contract is considered executed (or a clause for that set of satisfaction values is considered executed).

According to various example embodiments, the interpreter module 420 is configured to arrange execution values in one or more binary trees in a same arrangement as the one or more binary trees of the corresponding satisfaction values of the smart contract. The interpreter module 420 can further generate one or more execution hash values (ex: global execution hash values for the execution value of all of the transactions and/or partial execution hash values for sets of execution value of transactions or sub-transactions) from the execution values.

Based on the comparison of the satisfaction values of the smart contract (satisfaction hash values) with the execution values determined or derived from the transaction event entries (execution hash values), the interpreter module 420 is configured to output a status of a smart contract indicating whether the smart contract is fully executed or partially executed. The output can also indicate status of contract clauses or sub-clauses of the smart contract (ex: whether particular clauses are fully executed but the contract as whole has not been executed).

In some example embodiments, the interpreter module 420 can further indicate a status of the contract as being unresolved. In some situations, the interpreter module 420 can output relevant information, such as relevant clauses of the smart contract and relevant transaction event entries required for resolving the contract to a dispute resolution module 432. The dispute resolution module 432 can further provide this information to parties to the smart contract to permit resolving the contract outside of the execution validation system 400.

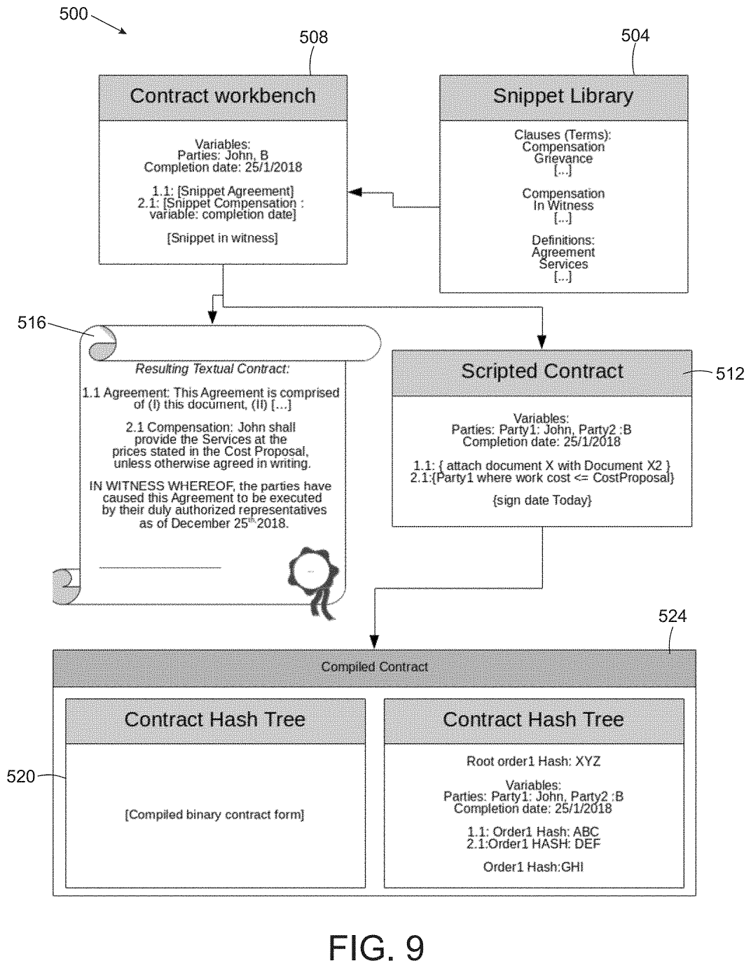

Referring now to FIG. 9, therein illustrated is a visual representation 500 of contract clause snippets used to build a machine-verifiable smart contract that can also be built and expressed using natural language. Use of contract clause snippets allows a user to build an electronically stored smart contract that can be validated according to various methods and systems described herein while also being expressible using natural language.

A contract snippet library 504 that stores a plurality of pre-defined contract clause templates (hereinafter also referred to as a “contract snippet”). A user can build a contract by selecting a set of pre-defined contract clause templates. A pre-defined contract clause template can define one or more of the following:
a natural language phrase for expressing a contract clause in natural language;
one or more variable fields and corresponding value fields for defining a satisfaction values each having a variable type and variable value;
one or more condition fields for defining one or more satisfaction values having a condition.

A contract snippet can contain various pieces of information that indicate the logical meaning of the snippet for computer-implemented validation of a contract clause created from the snippet. Interpretation of a clause created from a snippet may be performed with the help of a custom programmatic markup language that will basically explain the behavior in the form of a machine script. These scripts also define how to access event components in stored event entries, such as the parties to the contract, the expected time frames, and any other relevant variables added by the users or required by the contract. The scripts can also define how to derive or determine execution values or execution hash values from the data stored in transaction event entries. For example, the script can define functions or algorithms to be applied to data in event components of transaction event entries to determine execution values. The scripts can also define the structure of the execution values for generating the execution hash values that will be comparable to satisfaction hash values for determining execution of a contract clause of a smart contract. For example, the snippets containing the scripts can themselves be organized into a binary tree and the output of each script applied to data in the transaction event entries can be used to generate the execution hash value for that tree of snippets.

Built to take advantage of the blockchain's inheritance system and linked nature, the custom markup language is designed to allow to build human readable statements out of snippets of previously built elements. Each statement is built out of two main portions: a text generation markup elements which define how to establish human readable text generation, and a supporting programmatic scripting that imbues the text with procedural meaning for machines. The textual markup language allows to tag sections of the text with different identifiers and variables which can then be linked into the supporting programmatic script.

An important feature of these code snippets is that they are fully overridable, and any part of a snippet can be overlayed by another, changing the original meaning and merging both into a new one. The system 400 is capable of validating that the resulting meaning is still valid after the overrides combine as well as put it in relation with the other ones on the document to ensure soundness.

Snippets can also contain programmatic code cues that helps the system interpret the legal intent of the textual construct, as well as its behavior relative to inputs and outputs of other snippets. This computing hint language ensures that any portion of a statement can be overridden by new layers, giving it new meaning while still helping the system confirm that the intended behavior still matches the legal expectations. This statement stack can be flattened, compiled and utilized by the system to determine the merged clauses of the smart contract.

Each snippet is designed to be compiled and to be expressed in natural language, such as English, French, Spanish, Chinese or any other suitable language.

The language is formatted in such a way to allow any part of a phrase to be composed by snippets of code. For example in pseudocode, if a snippet is determined to produce the words [define:snippet1—“let there be”] and the another [define:snippet2—“light”], then the snippet [define:snippet3—[snippet1] [snippet2]] would produce the phrase “Let there be light”.

If the content of the block is to be overridden, for example by: [define:snippet4—[snippet3], [replace:snippet2—“peace on earth”]], then the result of this overlay would be: “Let there be peace on earth”. Any other block referencing snippet3 would still produce the same phrase “let there be light”. Snippet4 thus becomes an overlay, dependent on the meaning and content of the previous snippets from previous blocks it inherits from. These snippets will also be able to incorporate other snippets, just like programming code can include general functions which offer their own executable behavior. Accordingly snippets can be built into hierarchies of snippets, going from simple phrases and eventually forming complex paragraphs and documents.

The scripting language also allows for creation of higher order operations, statements and meanings for the machine which may be better adapted to contractual statements interpretation and flow. Special instructions may be created to operate on higher level legal language constructs and interpretation. Usual programmatic statements such as conditions, loops, functions and more can also be used to supplement meaning and embedded in this custom programmatic script language. These special operations will be understood and will be able to execute inside a custom build virtual machine engine.

The contract snippet can also indicate the natural language textual structure of a contract clause created from the snippet. These snippets will also contain language translation instructions which will enable a system that understands the scripting language (ex: contract assembler module 412) to generate a human readable version of the statements defined in a contract snippet.

Contract snippets can be layered within the smart contract. For example, for natural language expression of contract snippets, every inner snippet will generate its own language, which will be injected into the parents until full language paragraphs are formed. This language generation layer will be able to generate text in any language of the world based on the programmatic meaning of the underlying script and translation instructions. When the user will be crafting a contract on the user interface, they will see the human readable language result of the snippets in their preferred communication language, and not the programmatic statements (unless configured to also do so).

A contract workbench 508 is a user interface where a user can select pre-defined contract clause templates and enter desired satisfaction values in the fields of the templates to populate a smart contract. Accordingly, the user interface allows the user to build a smart contract by selecting a set of contract clauses and defining satisfaction values. The contract workbench 508 can also allow the user to create custom contract snippets.

Thus, the system will be able to interpret the contract in a programmatic form, and generate the contract in a textual form so that human users can read the language and understand its meaning, without ever looking at the programming substantiating the language behind it. By interpreting the programmatic meaning of the hierarchy of snippets, the system will be able to generate various visual aids to the user, such as contract structure and progress through time, branches of conditions, detect logical fallacies, detect conflicting statements and any other operations it can deduce from the code.

In the illustrated example, contract workbench 508 corresponding to information seen by a user shows that the user has defined variables “Parties” and “completion date”. The user has also chosen snippets “Agreement”, “Compensation” and “Witness” as well as defining a value for a “document” field in the “Agreement” snippet and a competition condition for the “compensation snippet”.

Scripted Contract representation 512 illustrates the electronically defined contract clauses and associated satisfaction values for a smart contract built from the values defined and snippets selected by the user via the contract workbench 508. For example, satisfaction value of the variable type and requiring a document having the value “Document X2” is defined in one of the clauses. A condition that the work cost be lower than value CostProposal is defined as a satisfaction value for contract clause “Compensation”.

Natural language representation 516 shows the natural language expression of the same smart contract.

Once a user completes building the smart contract, the smart contract can be complied for storage within first-order blocks of a blockchain. The smart contract can be complied in binary form 520. Satisfaction values of the contract can be arranged in a hash tree 524 so that each of the contract clauses have a respective satisfaction hash value and a root hash value for the entire smart contract is also generated.

According to one exemplary embodiment, first order blocks of the blockchain are used to build a linked list of programmatic statements that build on each other to establish legal meaning. When compiled, the statements are eventually flattened by the system who will parse the blockchain to generate a human readable and meaningful legal document.

Overlapping layers of overridable interlocking statements are created. These statements link to each other on the blockchain. Newer blocks link to previous parent blocks, which contain certain sets of permanent legal statements pre-formatted, verified and packaged into a structured library of language clauses. The newer block, by linking to the previous block automatically inherit all the statements and references of the previous block. It is then free to override previous blocks with its own changes, effectively creating a new “version” of the statements or contract clause. Any part of a statement can be overridden with the use of an expressive scripting language which codifies the modifications and their impact in the meaning. Any future block will link to the previous blocks will still remain intact, as the overlayed changes are only valid for blocks linking to the new block.

The legal contract descriptive language is very elaborate and designed to be machine friendly. In order to produce human readable format, a special renderer (or interpreter) is used which will parse all the blocks from the blockchain that are inherited by the linked list of references and will flatten each layer to produce a final human readable legal contract ready for binding agreements. By flattening the layers together, the meanings and codified interpretations will also flatten, affecting the meaning outcome.

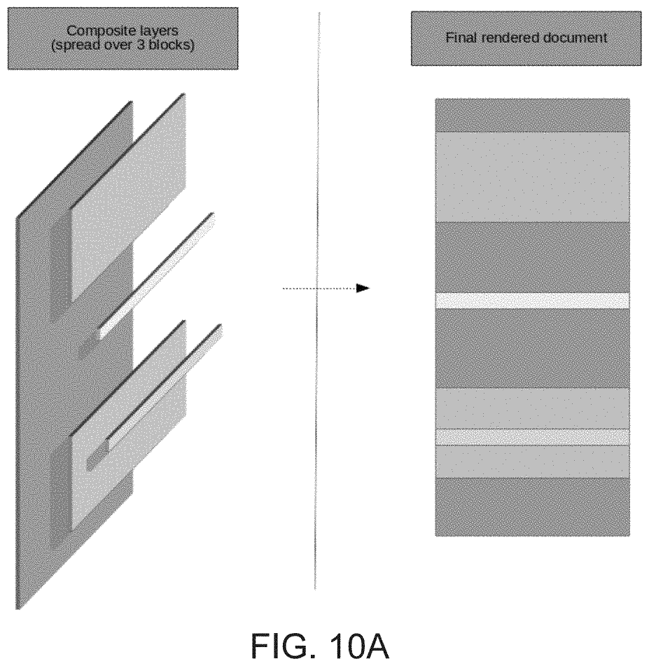

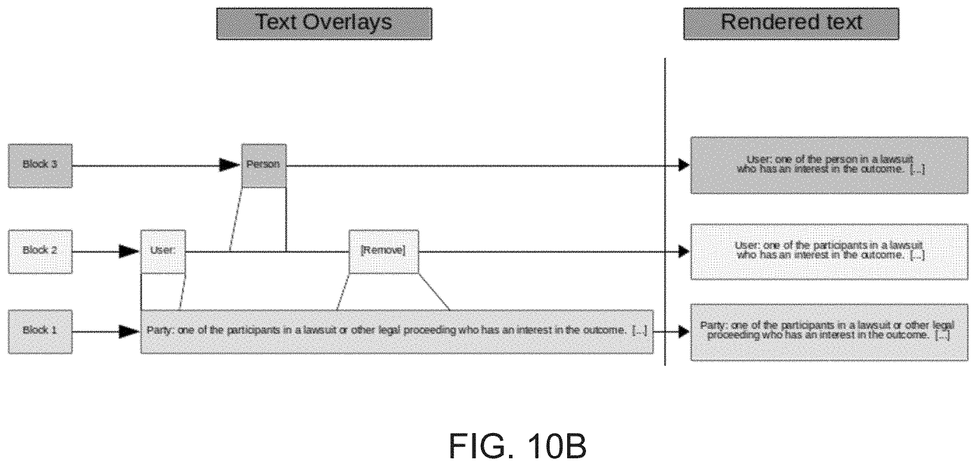

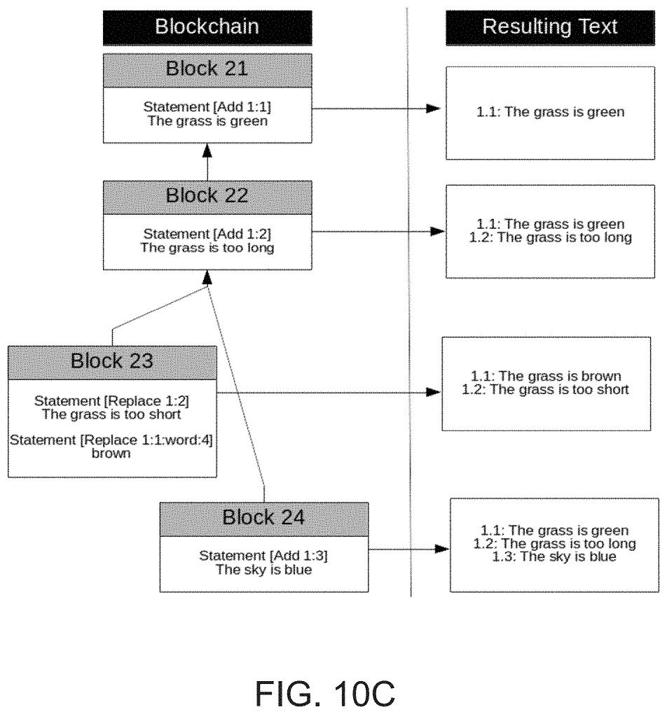

FIG. 10A illustrates a visual representation of composite layers of contract clause snippets and amendments and a representation of the smart contract generated from “flattening” the composite layers. Left-side representation shows 3 composite layers while right-side representation shows the composite layers being flattened to produce a final rendered document.

FIG. 10B illustrates a visual representation of an example of text overlays arranged in layers and stored in blocks. It will be appreciated that modifications to previous contract snippets are stored in subsequently appended blocks.

FIG. 10C illustrates a visual representation of the progression of a smart contract as amendments are made by modifying a clause or a adding a clause. It will be understood that while the example of FIG. 10C illustrates amendments to text strings, such amendments can also be applied to any portion of a contract clause/contract snippet.

By using this ability to build upon previous statements, a library of per-existing and user-verified snippets can be created. Eventually, users crafting contracts will simply need to reuse existing snippets, which will result in a simple link to the previous block reference. This will save disk space by limiting repetition, and in time, the vast majority of new contracts will take a minimal amount of disk space, being built of simple references instead. This will enable saving significant amounts of disk space, further resulting a greener application.

A beneficial effect of described blockchain's inheritance system is the ability to link to contract snippets, both as complete legal document sections, or simply special paragraphs and sections. Different legal snippets can represent any section of a document defined in a previously defined and linked block on the blockchain. These discrete legal components can be assembled to create a complete and whole legal text.

The ability of the block chain to organize statements in publicly available blocks of layers also allow the creation of reference snippet libraries that can be made publicly available. Each block statement that has been verified by a human claims agent, lawyer, case law or court judgment can then be passed on to another user to link to this block.

For the very same reason, the layers of legal documents become available as templates to link to and start building on. Because of the immutable nature of the first order blockchain, the users can be confident that their contracts on which they inherit will never change. This ensures a solid foundation for legal contract templates.

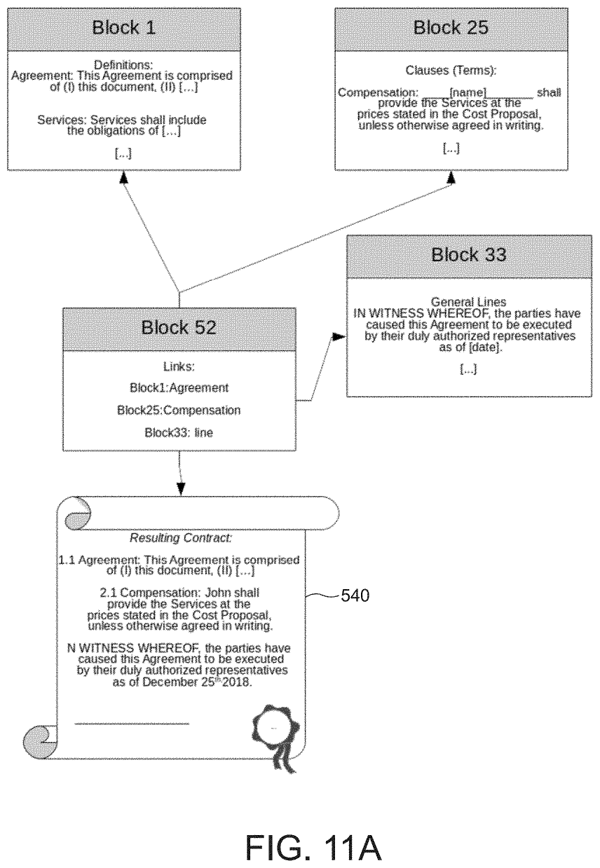

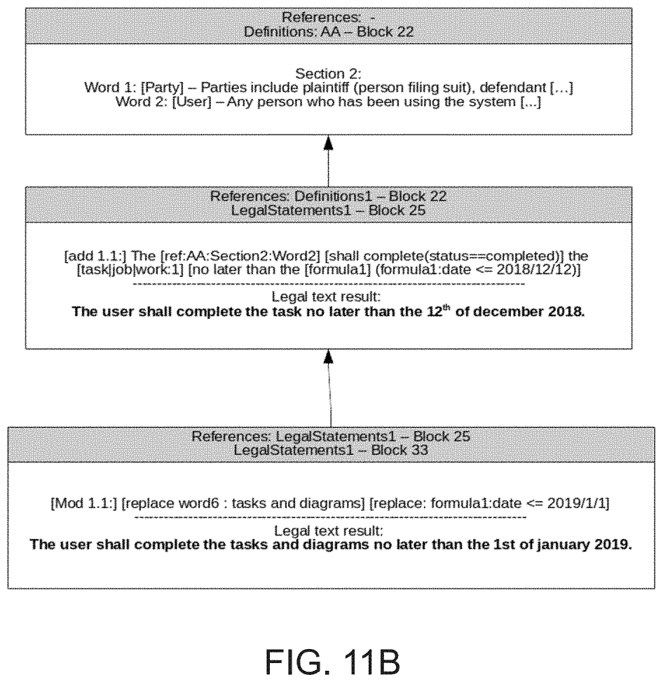

FIG. 11A illustrates a visual representation of contract snippets stored within a chain of blocks wherein a later block (block 52) references snippets stored in earlier blocks to form a result contract 540.

FIG. 11B illustrates a visual representation of snippets referencing other already stored snippets and further defining satisfaction values to define contract clauses of a smart contract. The resulting natural language expression of the snippets are also illustrated.

Referring back to FIG. 8, the execution validation system 400 further includes various modules permitting a user to build a smart contract. A predefined snippet library 504 stores one or more predefined snippets that are accessible to the user. The user can access the snippet library 504 as well as previously created snippets stored on the first order blockchain via the editing module 508. A compiler can further create the blocks corresponding to contract clauses created by the user via the editing module 508 using contract snippets. The compiler can further write the blocks to the first order blockchain via the first blockchain engine 404.

According to various example embodiments, a blockchain can further be configured to permit a given party to identify themselves when publishing transactions, such as transaction event entries 100 to a blockchain. An additional execution value for a transaction event entry can be the party carrying out the transaction, such as the identity of the party that uploaded a photo (ex: corresponding to box 212a in FIG. 4).

Furthermore, this identification can be provided without being integrally linked to a single unique public cryptographic key belonging to that given party. Accordingly, this allows for “decoupling” a party's identity from that unique public cryptography key. It will be appreciated that an important security issue in various blockchains is the integrity of a public key used to published blocks to a block chain and the private key of a party used to cryptographically generate the public key when accessing that blockchain. There have been many cases of a party's private key being compromised, such as being stolen or lost, which has serious repercussions for the original party. For example, assets (ex: cryptocurrency) owned by that party are now being accessed by someone else (where a private key is stolen) or no longer accessible at all (where a private key is lost).

According to an example embodiment for validating identity of a party to a blockchain transaction, a unique identifier can be attributed to a party, or actor, on a blockchain, whereby the unique identifier is not associated to a single unique public key. For example, the unique identifier can be a unique account number obtained from a unique hash of various information pertaining to the party, such as public keys associated to the party, the date and time of creation, etc. A proof of work and nonce to ensure a rate limiting factor for creation of new unique identifier by untrusted users can be implemented. A central identification authority can also be implemented to control the creation of new identifiers for parties wishing to transact on the blockchain.

Each unique identifier is further associated to a plurality of public keys. Each public key is derivable from a unique private key. During a party initialization transaction, the unique identifier and the plurality of public keys associated to that unique identifier are published within a block of the blockchain. Accordingly, the unique identifier and the associated public keys are visible to all parties operating on the block chain. For example, a party initialization transaction block can include the unique identifier associated to the given party, a first public key derived from a first private key associated to the party (ex: in the party's possession) and a second public key derived from a second private key associated to the party (ex: in the party's possession).

Subsequent to publishing the party initialization transaction, the party can provide its unique identifier and one of its public keys in any subsequent block in the blockchain. Of course, that public key is cryptographically generated from its associated private key belonging to that party.

Another actor, such as another device, can verify and validate the subsequent transaction by verifying the unique identifier and the presence of the public key. The verifying actor can compare the unique identifier and the public key of the subsequent transaction block with the identifier and set of public keys originally published in the party initialization transaction. The transaction is validated if both pieces of information are contained in the subsequent transaction block.

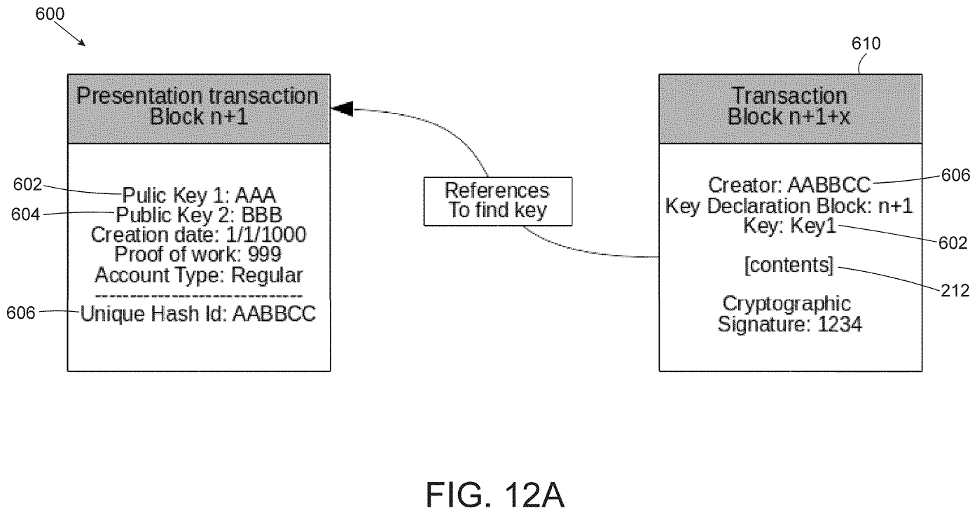

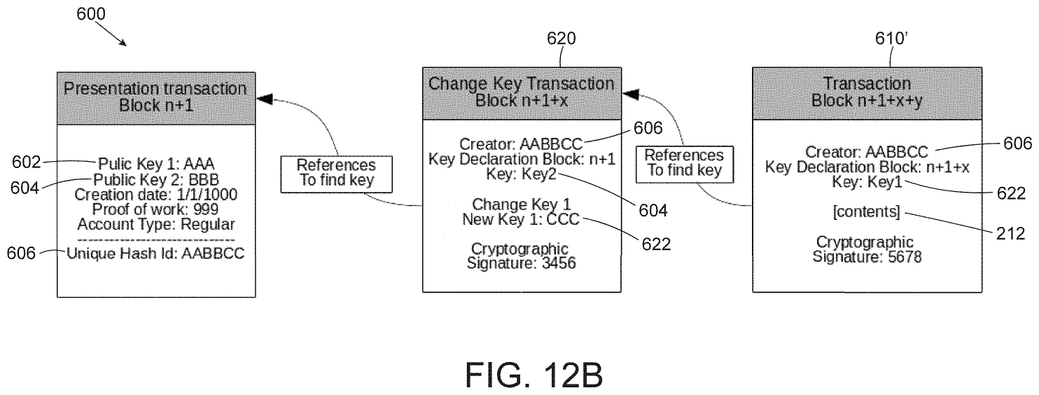

Referring now to FIG. 12A, therein illustrated is a visual representation of two blocks of an exemplary blockchain. The first block 600 is a party initialization block. As described above, the party initialization block includes a first public key 602 (“AAA”) and second public key 604 (“BBB”), as well as a unique identifier 606 in the form of a unique hash ID (“AABBCC”), all associated to the initializing party.

The second block 610 is a subsequent transaction block. This block includes the first public key 620 and the unique identifier 606 associated to the initializing party. This block also includes block contents 212, which may be transaction execution values, as described elsewhere herein.

As described hereinabove, when validating the second block 610, reference is made to the unique identifier 606 and the public keys 602, 604 published in the party initialization block 600.

A party can further publish an authentication update block to update and override identification information published in the party initialization block. In particular, the party initialization block includes the initial unique identifier, at least one public key published in the party initialization block and at least one key change entry. The key change entry changes the value of at least public key presented in the party initialization block. For example, the first public key can have its value changed—and therefore becomes a third public key that is derived from a third private key associated to the party. The second public key, which is the same as in the party initialization block, is presented to validate the identity of the party publishing the authentication update block.

After publishing the authentication update block, the party can then publish additional transaction blocks by providing its unique identifier and its public key having the changed value (i.e. the third public key). Accordingly, the public key of the party initialization block that has had a value change (i.e. the first public key) can no longer be used to validate identity of the party in subsequent transaction blocks.

When validating a transaction block published after the authentication update block, the validating party verifies the unique identifier and the presence of the public key having the changed value (the third public key). The subsequent transaction is determined as an invalid transaction if it does not contain the change-value public key.

Referring now to FIG. 12b, therein illustrated is a visual representation of three blocks of an exemplary blockchain that includes the party initialization block 600, an authentication update block 620, and a transaction block 610′ published subsequently to the authentication update block 620. The party initialization block 600 is permanently published to the blockchain and therefore is unchanged from its representation in FIG. 12a. The authentication update block 620 includes the unique identifier for the given party as well as the second public key 604 used to validate the identity. This validation can be made by referring back to the party initialization block 600. The authentication update block 620 also includes the change-value key 622 with value (“CCC”), which also corresponds to a third public key. This key can now be used in subsequent transaction blocks, such as block 610′. It will be appreciated that the subsequent transaction block 610′ now includes the third public key 622 and that during validation, reference is made to the authentication update block 620 to validate that transaction.

It will be understood that multiple authentication update blocks 620 can be chained over time, wherein each authentication update block includes the unique identifier and at least one public key of a previous authentication update block and at least one change-value public key. The public key of the previous authentication update block is used to validate the current authentication update block. The change value public key adds a new public key to be used for validating subsequent transaction block. The change value public key can also replace a previous public key so that that key can no longer be used for validating subsequent transaction blocks.

It will be appreciated that the above described chaining of a party initialization block and subsequent authentication update blocks allows a party to publish transaction blocks using its unique identifier. Furthermore, the identification and validation does not rely on a single unique public key. Instead, the chaining of authentication update blocks allows for changing the public key used for validating blocks over time. Accordingly, the identity of the party is decoupled from the public key it uses.

This decoupling further provides an additional level of security over using a single unique public key. For example, where a party is no longer in possession of a particular public key (ex: first public key 602), such as the associated private key being compromised (lost or stolen), that party can use a backup key (ex: second public key 604) that it still possesses to publish an authentication update block containing the backup key and a change-value key. Because the backup key was published in the party initialization block, it is known to all actors on the blockchain and there is consensus and useful for validation. The change-value key also becomes widely known and can be useful for validating subsequent transaction blocks. Furthermore, additional change-value keys can be published in subsequent authentication update blocks, as needed.

The validation of the transaction can be used in combination with the methods and systems for validating execution of a smart contract as described hereinabove. For example, each second-order transaction having execution values can be validated as necessary using the unique identifier and the published public key. Furthermore, the unique identifier contained in the second-order transaction can be one of the execution values of the transaction used to determine satisfaction of the smart contract.

The ability to validly identify a party to transaction blocks published on a blockchain can also be used for providing additional functionalities on a blockchain.

In one example application, since a unique identifier decoupled from public keys allows the party to operate while being uniquely identified on the blockchain, it also allows the system to assign special roles for some devices on the chain. For example, special centralized moderator devices can be created by presenting themselves and their public keys and identifying themselves as trusted nodes of the chain. From then on, any action performed by this identity on the chain, and signed by its promised public keys will ensure to the rest of the network that it is always sourced from this particular account. Thus, these special trusted nodes can perform special operations relating to their role that others can not do on chain, such as participating in consensus establishment, release block confirmations, send warning messages about malicious devices.

In another example application, using a constant unique identifier on the blockchain along with change-value public keys allows the system to correlate and evaluate the activity of these users on the blockchain over time. This allows the system to establish statistics about certain accounts, and based on their behavior, to assign them special trust values. As a node operates on the chain and respects the rules, its trust level may be increased, giving it special privileges not available to others. If an account misbehaves, then its trust level may be lowered, to a point where it may be completely banned from the network. Nodes on the network may behave differently when transactions are received from accounts that are trusted, versus others that are not.

In another example application, onchain behavior of a various parties can be monitored. By establishing certain rules on the blockchain, (for example, that no device (identified by ip address) shall operate more than 3 account numbers, and post more than 10 transactions daily) good acting parties and poor acting parties can be determined. Devices that respect these rules would operate unhindered on the network. But, accounts that would break these rules, such as a potentially unreliable third party websites operating multiple wallets for their users, would eventually get banned from the system. This methodology ensures proper control of high volume providers from operating and saturating the network or offer unreliable bulk services.

The blockchain rules would be published periodically by a node with the specific role to update these rules with special instruction transactions. When public nodes would receive these rules update, they would modify their behavior to reflect the new instructions.

In order to enable a select set of third party partners to operate volume transactions, those parties that are determined to be sufficiently trustworthy can be offered a special high volume certificate on the blockchain which would effectively give them an operating license to perform bulk operations on behalf of other users. A trusted node would emit a special certificate transaction on the blockchain that would identify the account to which the license applies to, as well as which accounts it is allowed to operate on behalf of. This license certificate would also contain other relevant information such as dates of validity, expiry date, etc. and would by signed by an identity which would have a special recognized role, such as a moderator.

When such a licensed operator would operate, they would append their certificate license identifier in their transactions before sending them on the peer to peer network. Other nodes forwarding the transactions to the network would receive these transactions and would notice the license certificate number included and validate it with the certificate published on chain. If the certificate is seen as valid, then they would allow the transaction and relay it to the network, where they would otherwise ban the account and IP address without such certificate.

This verification is made possible with the reference to the published account number. The certificate would, for example allow account number AAA to operate on behalf of account BBB, CCC and DDD.

Signature and reference to the public key published in an ulterior manner, the nodes can know that the owner of this transaction really is AAA, and would then validate the certificate. If they are operating on behalf of an account, say BBB, then BBB signature would also be included, confirming that the operator can operate as an operator for BBB, with its license certificate allowing it to operate for BBB.

Below is an example of a license that can be granted:

{
“CertificateId”: “033bd16d-1dda-4410-96eb-1d47f730063e”,
“CertificateVersion”: “1.0.0”,
“ModeratorUuid”: “28900372-717b-4de7-a1c9-ae6ca482ecc8”,
“KeyDeclarationBlockUuid”: “6dcc410c-878d-4121-9662-7d8b733e90de”,
“PartnerAccountUuid”: “cf0b25cc-7523-4401-bcfa-d6f6ee2d29ae”,
“PartnerWebsiteUrl”: “https://*.partnersite.com”,
“EmissionDate”: “2018-05-12T14:32:40.0547143Z”,
“ValidUntil”: “2019-05-12T14:32:40.0566328Z”,
“PermittedAccounts” : [“596ecc59-5597-44bb-b2c9-881ef52a3e6d”,“e0861fa8-
2fde-4e73-92d1- 839ca00d50ef”,“8a1a7475-8a3f-446d-b178-848c4cca74f97”],
“Hash”:
“25mHph9dhgGQQTCqdEUKSB15VkuxjHatc1RoLCt2DK1FYqJrk3DWmyFgHER
u4WM96”,
“Signature”:
“111LZ5rX7p7q22hN6HqjF3gfMvNU6hfYa7EZvL4pG7PhDvVq2XDA3pcAViEEE
bJKUut”
}

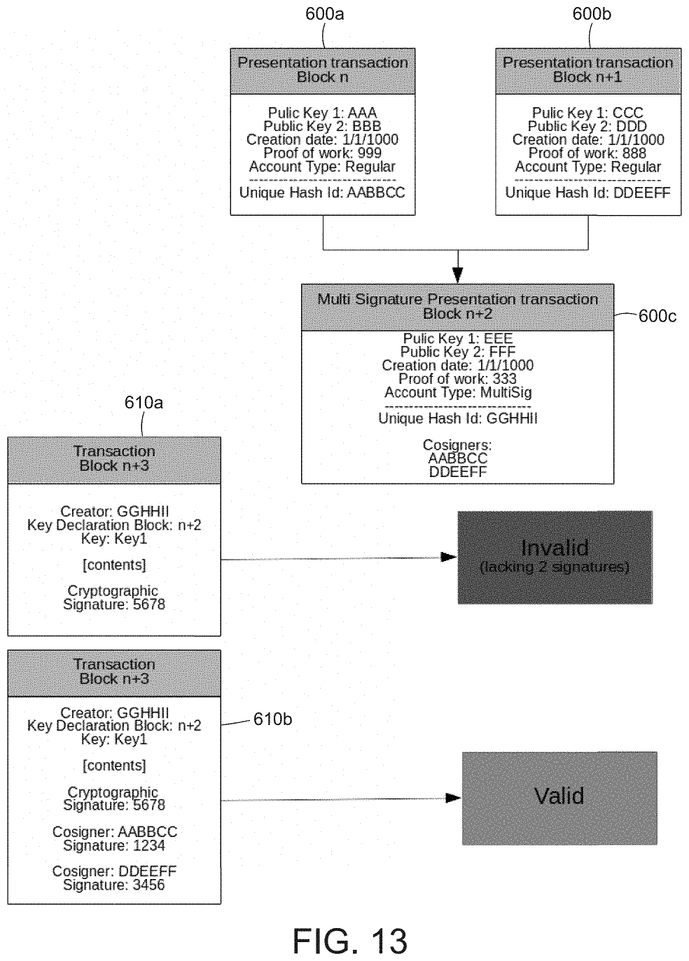

In yet another application, when a new unique identifier is created for a party, it is possible to link to it with other accounts as co-signers. When a new transaction is created for this account, it will be intercepted by the block emission devices and kept on hold for a predetermined grace period as it waits for extra events to correlate with this transaction. This centralized device will wait for other second order transactions from the other accounts list in this account to confirm their signature. If the required signatures are not received within the time frame allocated, the transaction will be deleted and voided as it times out. If all the required signatures are received, then the central device will declare this transaction as valid and confirm it with its own signature. FIG. 13 illustrates an example embodiment of multi-signature application, in which a first party initialization block 600a and a second party initialization block 600b are presented for two parties and a joint party initialization block 600c is also presented. A transaction block 610a having only one signature (one unique identifier) is considered invalid. A second transaction block 610b having both signatures (both unique identifiers) is considered valid.

In another application, it is possible to add in a party initialization block a correlation number which a centralized node can use to determine that this account is specially registered and must be handled in a special manner. If the centralized node receives a transaction from this account and realizes that it requires multiple factor authentication for example, then the central device will hold the transaction for a specific period of time, so that it can perform off the blockchain what needs to be done to confirm that the owner of the account really intended to send this transaction. If the owner confirms the transaction off the blockchain, then the central device will confirm the transaction. If nothing is confirmed, the transaction will time out, be deleted and be voided. This mechanism can be very useful to prevent key theft.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A method for validating execution of a smart contract, the method comprising:
storing the smart contract within a blockchain having at least one first order block, the smart contract having a set of electronically-defined contract clauses, each clause being defined by at least one satisfaction value, the combination of the satisfaction values of the set of contract clauses having a satisfaction hash value for the smart contract;
reading a set of one or more electronically-stored second order transactions each having a subset of one or more execution values;
selecting, from the set of electronically-stored second order transactions, a subset of transactions corresponding to the contract clauses of the smart contract;
determining an execution hash value of the combination of execution values of the subset of transactions; and
determining the smart contract as being fully executed if the execution hash value of the combination of execution values of the subset of transactions matches the satisfaction hash value of the smart contract.

2. The method of claim 1, wherein a satisfaction value defines one of:
a presence of a condition indicatable by an execution value, and
a value of a variable indicatable by an execution value.

3. The method of claim 1, wherein the second order transactions are stored as transaction event entries each having at least one event component;
wherein each second order transaction is represented by one or more event components; and
wherein each execution value is determined from at least one event component.

4. (canceled)

5. The method of claim 3, wherein the transaction event entries are stored within one or more second order blocks of a blockchain.

6. The method of claim 1, wherein the second order blocks are stored within the blockchain having the at least one first order block, the second order blocks being distinguishable from the at least one first order block.

7. The method of claim 1, wherein the second order blocks are stored within an additional blockchain independently of the blockchain having the at least one first order block.

8. (canceled)

9. (canceled)

10. The method of claim 1, wherein the execution hash value of the combination of execution values of the subset of second order transactions matching the satisfaction hash value for the smart contract represents a state wherein the second order transactions have a combination of execution values matching the combination of satisfaction values of the smart contract, thereby further indicating that all of the contract clauses of the smart contract have been satisfied.

11. (canceled)

12. The method of claim 1, further comprising:
storing an amendment to the smart contract within at least one new block of the one or more first order blocks.

13. The method of claim 12, wherein the amendment to the smart contract comprises one or more of:
a modification to a given contract clause of the smart contract, whereby the at least one new block indicates an update to at least one satisfaction value of the given contract clause; and
an addition of at least one new contract clause to the set of contract clauses, whereby the at least one new block indicates at least one new satisfaction value for each of the at least one new contract clause.

14. The method of claim 12, wherein the amended smart contract has an updated set of electronically defined contract clauses and wherein the combination of satisfaction values of the updated set of contract clauses has an updated satisfaction hash value;
the method further comprising:
selecting, from the set of electronically-stored second order transactions, an updated subset of transactions corresponding to the updated set of electronic defined contract clauses of the amended smart contract;
determining an updated execution hash value of the combination of execution values of the updated subset of transactions; and
determining the amended smart contract as being fully executed if the updated execution hash value matches the updated satisfaction hash value for the amended smart contract.

15. The method of claim 1, further comprising:
publishing a party initialization transaction within a block of the blockchain, the party initialization transaction comprising:
a unique identifier associated to a given party;
a first public key derived from a first private key associated to the party; and
a second public key derived from a second private key associated to the party; and
wherein at least one given transaction of the subset of transactions comprises the unique identifier as one of its execution values; and
wherein the at least one given transaction is validated as a valid transaction based on the given transaction containing the first public key cryptographically generated from the party providing the first private key.

16. (canceled)

17. The method of claim 15, further comprising publishing an authentication update block comprising:
the unique identifier;
the second public key cryptographically generated from the party providing the second private key; and
a third public key derived from a third private key associated to the party; and
wherein a given transaction of the subset of transactions occurring after the authentication update transaction is determined as a valid transaction if it contains the third public key cryptographically generated from the party providing the third private key; and
wherein another given transaction of the subset of transactions occurring after the authentication update transaction is determined as an invalid transaction if it does not contain the third public key.

18. (canceled)

19. (canceled)

20. (canceled)

21. (canceled)

22. (canceled)

23. A computer-implemented system for validating execution of a smart contract, the system comprising:
at least one data storage device;
at least one processor coupled to the at least one storage device, the at least one processor being configured for:
storing the smart contract within a blockchain having at least one first order block, the smart contract having a set of electronically-defined contract clauses, each clause being defined by at least one satisfaction value, the combination of the satisfaction values of the set of contract clauses having a satisfaction hash value for the smart contract;
reading a set of one or more electronically-stored second order transactions each having a subset of one or more execution values;
selecting, from the set of electronically-stored second order transactions, a subset of transactions corresponding to the contract clauses of the smart contract;
determining an execution hash value of the combination of execution values of the subset of transactions; and
determining the smart contract as being fully executed if the execution hash value of the combination of execution values of the subset of transactions matches the satisfaction hash value of the smart contract.

24. The system of claim 23, wherein a satisfaction value defines one of:
a presence of a condition indicatable by an execution value, and
a value of a variable indicatable by an execution value.

25. The system of claim 23, wherein the second order transactions are stored as transaction event entries each having at least one event component;
wherein each second order transaction is represented by one or more event components; and
wherein each execution value is determined from at least one event component.

26. (canceled)

27. The system of claim 25, wherein the transaction event entries are stored within one or more second order blocks of a blockchain.

28. The system of claim 23, wherein the second order blocks are stored within the blockchain having the at least one first order block, the second order blocks being distinguishable from the at least one first order block.

29. The system of claim 23, wherein the second order blocks stored within an additional blockchain independently of the blockchain having the at least one first order block.

30. (canceled)

31. (canceled)

32. The system of claim 23, wherein the execution hash value of the combination of execution values of the subset of second order transactions matching the satisfaction hash value for the smart contract represents a state wherein the second order transactions have a combination of execution values matching the combination of satisfaction values of the smart contract, thereby further indicating that all of the contract clauses of the smart contract have been satisfied.

33. (canceled)

34. The system of claim 23, wherein the processor is further configured for:
storing an amendment to the smart contract within at least one new block of the one or more first order blocks.

35. The system of claim 34, wherein the amendment to the smart contract comprises one or more of:
a modification to a given contract clause of the smart contract, whereby the at least one new block indicates an update to at least one satisfaction value of the given contract clause; and
an addition of at least one new contract clause to the set of contract clauses, whereby the at least one new block indicates at least one new satisfaction value for each of the at least one new contract clause.

36. The system of claim 34, wherein the amended smart contract has an updated set of electronically defined contract clauses and wherein the combination of satisfaction values of the updated set of contract clauses has an updated satisfaction hash value;
the processor is further configured for:
selecting, from the set of electronically-stored second order transactions, an updated subset of transactions corresponding to the updated set of electronic defined contract clauses of the amended smart contract;
determining an updated execution hash value of the combination of execution values of the updated subset of transactions; and
determining the amended smart contract as being fully executed if the updated execution hash value matches the updated satisfaction hash value for the amended smart contract.

37. The system of claim 23, wherein the processor is further configured for:
publishing a party initialization transaction within a block of the blockchain, the party initialization transaction comprising:
a unique identifier associated to a given party;
a first public key derived from a first private key associated to the party; and
a second public key derived from a second private key associated to the party; and
wherein at least one given transaction of the subset of transactions comprises the unique identifier as one of its execution values; and
wherein the at least one given transaction is validated as a valid transaction based on the given transaction containing the first public key cryptographically generated from the party providing the first private key.

38. (canceled)

39. The system of claim 37, further comprising publishing an authentication update block comprising:
the unique identifier;
the second public key cryptographically generated from the party providing the second private key; and
a third public key derived from a third private key associated to the party; and
wherein a given transaction of the subset of transactions occurring after the authentication update transaction is determined as a valid transaction if it contains the third public key cryptographically generated from the party providing the third private key; and
wherein another given transaction of the subset of transactions occurring after the authentication update transaction is determined as an invalid transaction if it does not contain the third public key.

40. (canceled)

41. (canceled)

42. (canceled)

43. (canceled)

44. (canceled)
